(19) United States
(12) Patent Application Publication
(10) Pub. No.: US 2011/0083519 A1
(43) Pub. Date: Apr. 14, 2011

(54) Correlating Push Force and Stalk Vibration to a Plant's Susceptibility to Stalk Lodging and Brittle Snap

(75) Inventors: Roberto Barreiro, Honolulu, HI (US); Christopher L. Baszczynski, Earlham, IA (US); Terry EuClaire Meyer, Urbandale, IA (US)

(73) Assignee: Pioneer Hi-Bred International, Johnston, IA (US)

(21) Appl. No.: 12/577,377

(22) Filed: Oct. 12, 2009

(51) Int. Cl. G01L 1/10

(52) U.S. Cl. 73/862.59

(57) ABSTRACT

The present device enables measurement of the susceptibility of corn plants to stalk lodging and brittle snap. The device is used to push over a corn stalk and the force used to push over the stalk, and the vibration of the stalk caused by the push are recorded. As material breaks in the stalk, an accelerometer, measures stalk vibration response to the breaking events; the data is then recorded to allow quantitative measurements of the susceptibility of corn plants to stalk lodging and brittle snap. This allows meaningful comparisons of various hybrids at early stages of hybrid evaluation and advancement.

### FIELD OF THE INVENTION

This invention relates to a method and device for measuring the susceptibility of corn plants to stalk lodging and brittle snap. The invention provides a way of measuring and recording stalk lodging and brittle snap so the data can be specifically used to provide meaningful information in hybrid corn breeding to facilitate the development of corn plants having good stalk lodging and brittle snap properties.

### BACKGROUND OF THE INVENTION

Corn is an important and valuable field crop. Thus, a continuing goal of plant breeding is to develop stable, high yielding corn hybrids that are agronomically sound. The reasons for this goal are obvious: To maximize the amount of grain produced on the land and to supply food for both animals and humans.

The overall goal of a corn plant breeder is to combine, in a single variety/hybrid, various desirable traits of the parental lines. For field crops, these traits may include resistance to diseases and insects, tolerance to heat and drought, reducing time to crop maturity, greater yield, and better agronomic qualities. The mechanical harvesting of many crops has placed increased importance on the uniformity of plant characteristics such as germination, stand establishment, growth rate to maturity, and fruit size.

In order to have the plants stand tall and withstand the various mechanical forces applied by wind, rain, harvesting equipment, etc., it is important that the plant stalk have good mechanical properties and that the roots are firmly anchored into the soil. Otherwise, the stalks may bend, break or be pulled out, leading to the loss of a harvestable ear.

It has become common place for corn plant breeders to use a set of fairly standard definitions for characterization of the mechanical properties of roots and stalks. For example, brittle snap is a measure of the stalk breakage below the ear during ear development and is an indication of whether a hybrid will snap or break near the time of flowering, under severe winds. Data is often presented as a percentage of plants that do not snap after a wind event.

Stalk lodging, is a trait measured near harvest time, and is scored as the percentage of plants that do not exhibit stalk breakage at the base of the plant, when measured either by observation of natural lodging in the field, or by physically pushing on stalks, and then determining the percentage of plants that break or do not break at the base of the plant.

Root lodging is a trait scored as the percentage of plants in a plot or field that do not exhibit excess leaning of the plant from the normal vertical axis. Typically, plants that lean from the vertical axis at an approximately 30 degree angle or greater would be counted as lodged. Root lodging often is reported as a rating of one to nine where a higher score indicates less root lodging potential (one is very poor, five is intermediate, and nine is very good, respectively for resistance to root lodging). There are two types of root lodging, early root lodging and late root lodging. Early root lodging occurs right before flowering. Late root lodging occurs within approximately two weeks of anticipated harvest or after pollination. Late root lodging is more problematic because of the inability of the plant to recover before harvest, which results in consequent yield losses.

Both early and late root lodging occur as a result of the interaction between the root system, the soil and the wind force pushing the plants during a storm. In moisture saturated soils, frictional forces between the root system and the soil particles are significantly reduced allowing the root to rotate when a lateral force is applied to the stalks. This rotation is in the direction of the force vector after the consequent lodging.

As those skilled in agricultural arts know, nearly every part of the corn plant has a use. Corn is used as human food, livestock feed, and as a raw material in many industries. The food uses of corn, in addition to human consumption of corn kernels, include products of both dry- and wet-milling industries. The principal products of corn dry milling are grits, meal and flour, while the corn wet-milling industry provides starch, syrups, and dextrose for food use. Corn oil is recovered from corn germ, which is a by-product of both dry- and wet-milling industries.

Corn is also used extensively as livestock feed primarily for beef cattle, dairy cattle, hogs, and poultry.

Industrial uses of corn are mainly from corn starch, from the wet-milling industry, and corn flour from the dry-milling industry. The industrial applications of corn starch and flour are based on its functional properties, such as, viscosity, film formation, adhesive properties, and the ability to suspend particles. Corn starch and flour have applications in both the paper and textile industries. Other industrial uses include applications in adhesives, building materials, foundry binders, laundry starches, explosives, oil-well muds, other mining applications, and for ethanol production.

Plant parts other than the grain of corn are also used in industry. Stalks and husks are made into paper and wallboard and cobs are used for fuel and to make charcoal.

Growers thus are interested in producing corn plants that have the very best grain or plant quality properties, produce the highest yield and therefore have the greatest potential for income.

An embodiment of the present invention provides a method and means of objectively measuring the susceptibility of corn plants to stalk lodging and brittle snap.

A further embodiment of the present invention provides a device which objectively measures a corn plants' susceptibility to stalk lodging and brittle snap that is relatively inexpensive, easy to make and easy to use.

An embodiment of the present invention provides a method and device that can be used to test more effectively a hybrid's susceptibility to stalk lodging and brittle snap earlier in the product development cycle of a new hybrid than existing standard methods. Moving the testing for these traits much earlier in the development cycle allows for selection and advancement of the more desirable lines more easily, and at a point in the process when seeds of a new hybrid are relatively limited in numbers, which poses constraints with traditional methods that typically require more plants per hybrid for evaluation of stalk lodging and brittle snap. Also, traditional methods of scoring for such lodging and brittle snap depend on growing the plants in many locations in an attempt to have some locations present where naturally occurring environmental conditions occur, especially damaging winds that occur at key developmental stages. The present invention allows testing of the plants as needed, and is not dependent on the chance that a damaging wind might or might not occur, and so provides for a more reliable and resource efficient approach to testing for such traits. These embodiments as well as numerous benefits of the present invention will become apparent from the detailed description of the invention which follows hereinafter.

### BRIEF SUMMARY OF THE INVENTION

A device to identify the susceptibility of corn plants to stalk lodging and brittle snap is provided. The device is used to push on a corn stalk and the force used to push on the stalk, and the vibration of the stalk during the test is recorded. As material breaks within the stalk, an accelerometer measures stalk vibration in response to the breaking events; the data is recorded to allow meaningful measurements and analysis of susceptibility of plant stalks to breakage. This allows for screening of various hybrids for their susceptibility to stalk lodging and brittle snap.

### BRIEF DESCRIPTION OF THE DRAWINGS

FIG. 1 is a schematic of the test setup, including the data acquisition system.

FIG. 2 is a perspective view of the components of the invention as applied to the lower portion of a corn stalk ready for measurements.

FIG. 3 is a perspective view of an additional embodiment of the invention.

FIG. 4 is a perspective view of the embodiment of FIG. 3 in an engaged position.

FIG. 5 is a side view of the embodiment of FIG. 3.

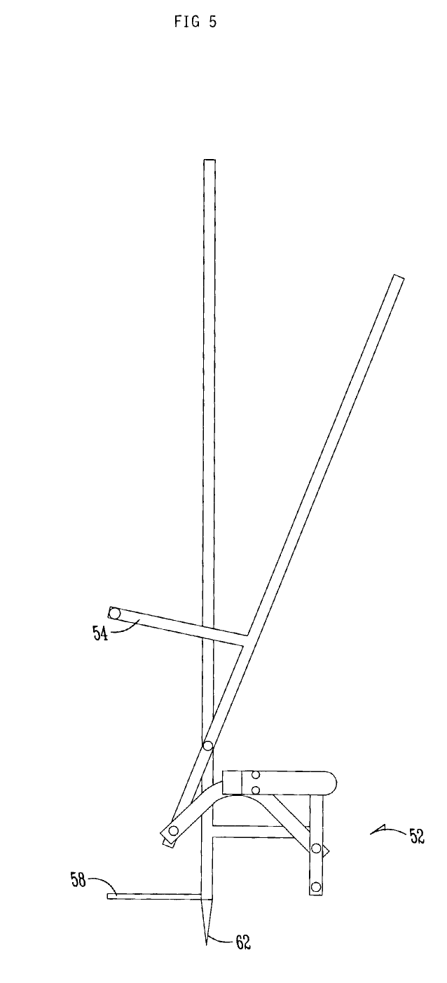

FIG. 6 shows a residual plot for counts of fiber breakage for brittle snap testing.

FIG. 7 shows an interation plot for the total acceleration for brittle snap testing.

FIG. 8 shows a boxplot of the number of counts for hybrids 1-4 after the stalk was pushed from the vertical position to the horizontal position (a rotation of 90°).

FIG. 9 shows residual plots for the number of counts for hybrids 1-4 (number of fibers reaching structural failure) measured with the accelerometer during a breaking event.

FIG. 10 shows a boxplot of the number of counts for hybrids 5-8 after the stalk was pushed from the vertical position to the horizontal position (a rotation of 90°).

### DETAILED DESCRIPTION OF THE PREFERRED EMBODIMENTS

The device is used to measure the susceptibility of corn plants to stalk lodging and brittle snap. When used to push on a corn stalk, the force applied on the stalk and the vibration of the stalk due to stalkbreakage during the test is recorded. Stalksbreak as a consequence of the applied lateral force. These breakage events are measured by an accelerometer, which measures stalk vibration. A software program (using Matlab, available from The Mathworks, Inc., Natick, Mass.) was written to correlate the number of breakage events in the accelerometer response and the input force to the known strength of the hybrid. It is within the skill of the art to determine the appropriate threshold of signal to noise ratio for optimal use of the device. The device can be used in early hybrid development to test for susceptibility to stalk lodging and brittle snap, before a large number of seeds are available for broad field testing, thus moving the opportunity for testing for these traits earlier in the development cycle of a new hybrid.

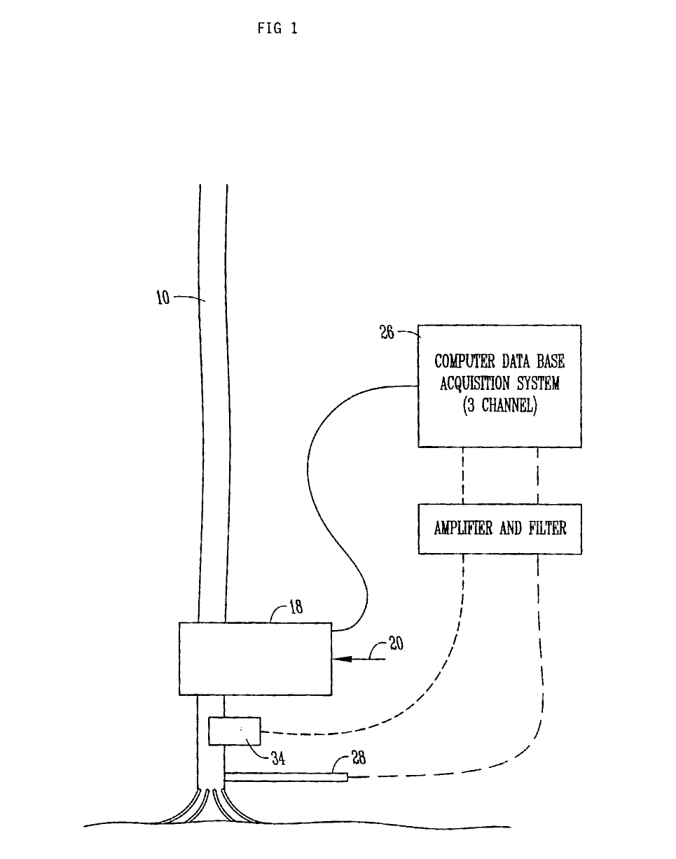

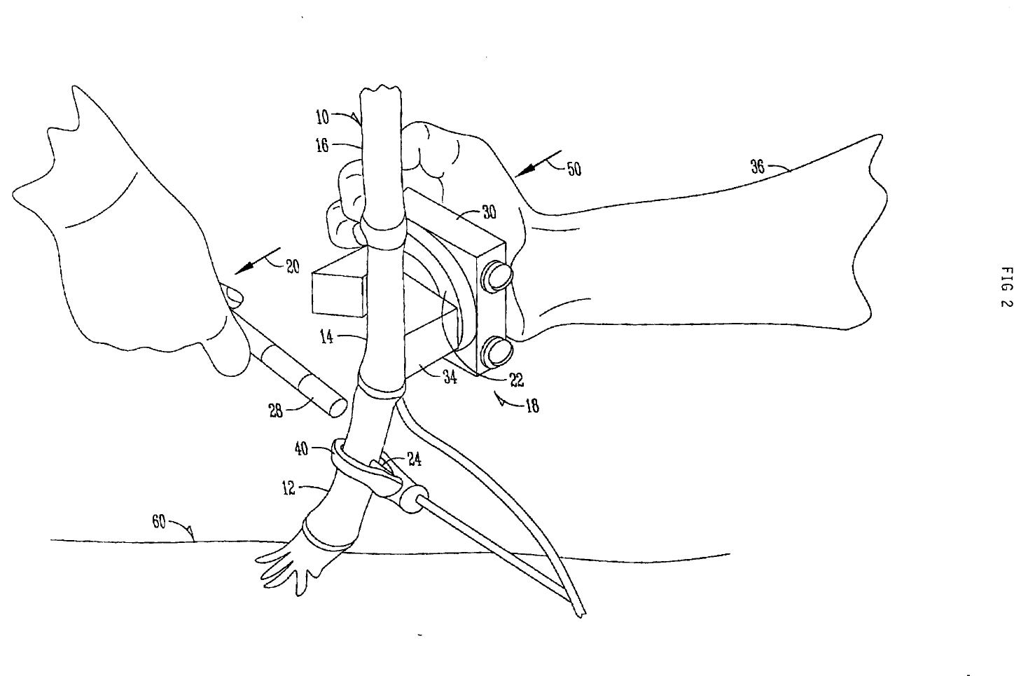

FIG. 1 is a schematic of the test setup, including the data acquisition system. A corn stalk, best illustrated in FIG. 2 at 10, has at its lower portion first, second and third internodes 12, 14 and 16, respectively. The applied test force 50 from the test device 18 is applied along the directional arrow 20 (manually as explained below), and an associated force transducer 22 records this applied force 50. The applied force 50 is preferably applied at the second or third internodes, 14 and 16, respectively.

An accelerometer 24 is attached to the plant, as illustrated in FIG. 2, preferably at or above the first internode 12 and records the stalk vibrations as the stalk lodging or brittle snap occurs. The information is then stored in a computer 26 (see FIG. 1). A microphone 28 may be used to amplify the sound of stalk lodging or brittle snap which can also be stored for later analysis if desired. The microphone aspect is, however, optional, since it also picks up background noise.

Turning from the schematic of FIG. 1 to the actual device 18, as shown in FIG. 2, it should first be mentioned that initial tests were run to determine what sort of device should be used to provide consistent results. It was determined that a device designed to measure the force used to generate stalk lodging and brittle snap and the sound and stalk vibrations generated during the stalk lodging or brittle snap event would provide the desired consistent results. This measurement allows for reproducible early testing of hybrids. It was during this investigative process that it was discovered that accurate data was obtained with a handheld device, versus one that uses a mechanical drive and motor to push on the corn stalk. A device with a mechanical drive and motor to push on the stalks has its own mechanical vibrations and audible noise, both of which can interfere with obtaining accurate counts and generating consistent data. Thus an important feature for the present invention is that it is a handheld or easily portable device using manual pushing against a backing plate 30 to apply force to a plant stalk, leading to a stalk lodging or brittle snap event.

The backing plate 30 can be made from a variety of materials, including but not limited to, metals, plastics, Teflon®, nylon and wood. Specifically, an aluminum backing plate 30 is satisfactory. Force transducer 22 is mounted to the backing plate 30 so that the force 50 applied on the transducer 22 is measured. Stalk holder 34, is a plate with a V-notch in its front, and which can also be made from numerous materials as described above, is mounted, for example, with a screw to the center mounting plate of the force transducer 22. The notch portion of the V-notch of stalk holder 34 is applied against the longitudinal axis of the corn stalk to allow the force 50 to be applied perpendicular to the stalk. In this way, the user is assured force 50 is applied at the correct location. Other suitable notch shapes may be used in the present invention such as a U-notch or any variation that enables the stalk to be held in place while the test is run.

The force transducer 22 can be, but does not necessarily have to be a Loadstar AS-C-50-025 load sensor, available from Loadstar Sensors, Inc., Fremont, Calif. It is within the skill in the art to determine the suitability of other readily available force transducers. As illustrated in FIG. 2, backing plate 30, force transducer 22 and stalk holder 34 are placed at the second or third internodes, 14 and 16, respectively, as illustrated and then force 50 is applied as a human operator 36 pushes against the stalk 10.

The accelerometer 24 (one suitable example is PCB 35 2A60, available from PCB Piezotronics, Depew, N.Y.) is then positioned adjacent to corn stalk 10 at its lower end, either at the first or second internodes 12 and 14, respectively. As illustrated in FIG. 2, accelerometer 24 is affixed into the operative position by any suitable means. As illustrated here, accelerometer 24 is mounted using a velcro strip 40 circling the stalk 10 at or above the first internode 12 near the ground 60. The velcro strip 40 is then attached to the accelerometer 24 to hold the accelerometer 24 against the stalk 10. In this way, the vibration is sensed by the accelerometer 24 as the pushing force 50 causes mechanical breakage of the stalk. Alternatively, accelerometer 24 may be mounted using pins or spikes (not shown) that are inserted into the stalk 10. The pins or spikes may be made of any suitable material so long as the accelerometer 24 is held against the stalk 10 such that the vibration is sensed by the accelerometer 24 as the pushing force 50 causes mechanical breakage of the stalk.

As illustrated, microphone 28 may be held near to the ground 60 at the base of the stalk 10 in order to record the sound of the breaking events. However, the sound captured from the breaking root events, as opposed to the vibrations, has been found to be a less reliable predictor since the former is subject to also capturing background noise from a variety of other sources in the vicinity.

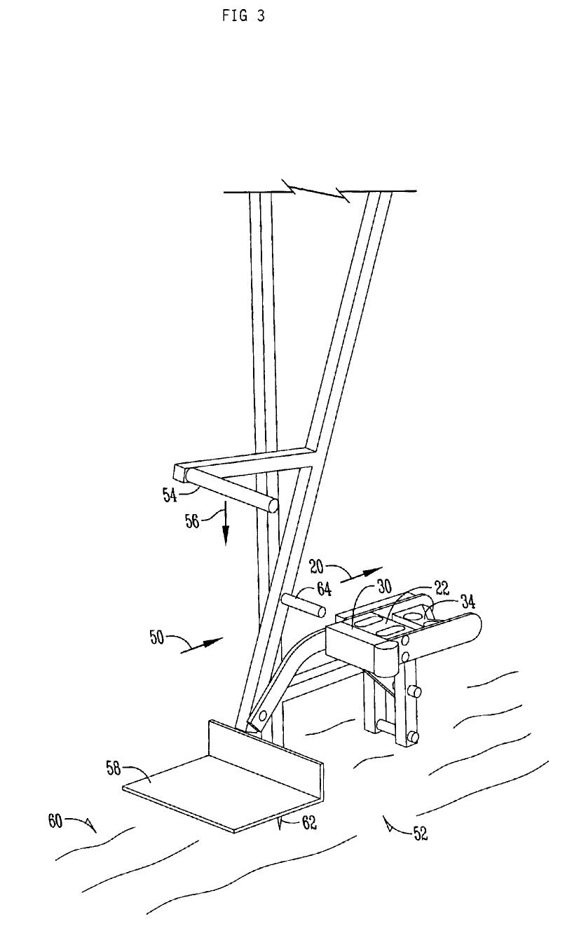

A further embodiment of the present invention is shown in FIG. 3. The applied test force 50 from the test device 52 is applied along the directional arrow 20, wherein an operator (not shown) places a foot on bar 54 and pushes down along directional arrow 56 along pivot point 64, and an associated force transducer 22 records this applied force 50. Pivot point 64 may also be a cam mechanism (not shown). The applied force 50 is preferably applied at the second or third internodes, 14 and 16, respectively of the corn plant (not shown). Plate 58 of test device 52 is anchored to the ground 60 by spike 62. Plate 58 can be made from a variety of materials, including but not limited to, metals, plastics, Teflon®, nylon and wood. Specifically, an aluminum plate 58 is satisfactory. Spike 62 may be made from a variety of materials, including but not limited to, metals, plastics, Teflon®, nylon and wood. Specifically, an aluminum spike 62 is satisfactory. Spike 62 is securely fastened to the ground 60 to prevent movement of plate 58 of test device 52.

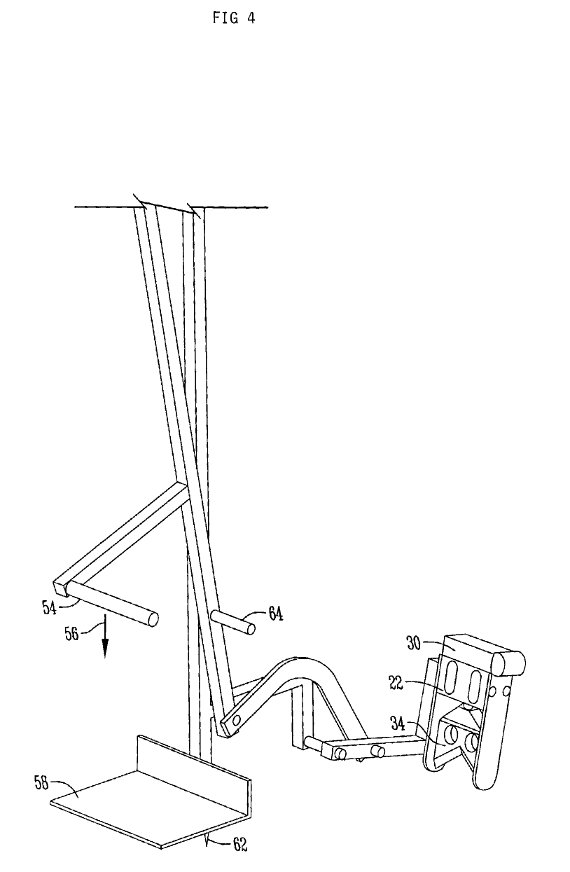

An accelerometer 24 is attached to the plant, as illustrated in FIG. 2, and as previously described. The backing plate 30 can be made from a variety of materials, including but not limited to, metals, plastics, Teflon®, nylon and wood. Specifically, an aluminum backing plate 30 is satisfactory. Force transducer 22 is mounted to the backing plate 30 so that the force 50 applied on the transducer 22 is measured. Stalk holder 34, which is a plate with a V-notch in its front, and which can also be made from numerous materials as described above, is mounted, for example, with a screw to the center mounting plate of the force transducer 22. The notch portion of the V-notch of stalk holder 34 is applied against the longitudinal axis of the corn stalk to allow the force 50 to be applied perpendicular to the stalk. In this way, the user is assured force 50 is applied at the correct location. This is illustrated more fully in FIG. 4. Other suitable notch shapes may be used in the present invention such as a U-notch or any variation that enables the stalk to be held in place while the test is run.

The devices described herein can be used to push on individual plants to simulate stalk lodging and brittle snap. During the push, the force, the stalk vibration and the sound (optional) are measured. As illustrated in the schematic of FIG. 1, all were measured as time signals recorded into a personal computer based multi-channel data acquisition system. The signals were sampled at 30,000 Hz with 200,000 data points collected for each plant. The long sampling time was used to ensure that the complete lodging or brittle snap event was captured.

The accelerometer and the microphone signals were amplified and passed through an anti-aliasing filter with a 15,000 Hz cutoff frequency. The force transducer signal was input directly to the data acquisition system.

While the embodiments described above use a pushing force it is within the skill in the art to modify the apparatus to use a pulling force on a corn stalk. The pulling force applied to the stalk and the vibration of the stalk due to stalk lodging or brittle snap during the test is recorded as described above.

During field testing as described below in the Examples, the data acquisition system was located at the edge of the field and 150 foot long cables were used to connect the computer based data acquisition system with the power supply of the microphone, accelerometer and the force transducer. It should be noted that each device was located within approximately 3-5 feet of its power supply. The cable lengths used here did not produce any discernable loss in measuring signals. All electronic devices in the field testing were powered by one portable gas powered generator, and may be powered by other readily available appropriate sources of power.

### EXAMPLES

The following examples are illustrative and not limiting. One of skill will recognize a variety of non-critical parameters that can be altered to achieve essentially similar results.

### Example 1

### Brittle Snap Testing

Two Pioneer hybrids were assessed, one with weak roots and one with strong roots, based on earlier testing and characterization of the hybrids. The testing consisted of twenty plants and forty measurements per treatment. The accelerometer 24 was place on the internode just below the primary ear node of the corn stalk. Two measurements were taken for each plant. The primary ear node was snapped by hand first and the node directly below the primary node was snapped second. All leaves were stripped from the plant before measurements were taken.

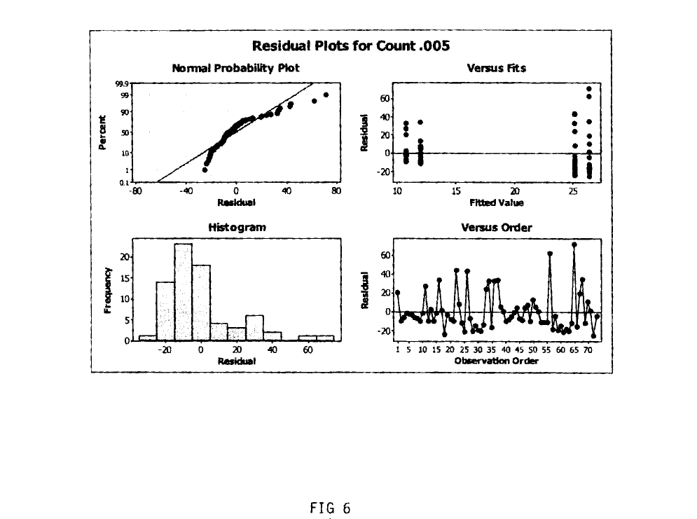

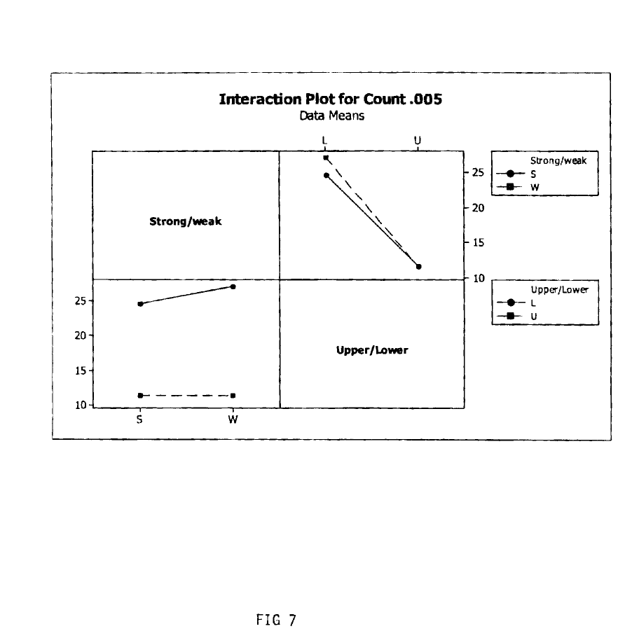

The counts of stalk fiber failure were taken from the function. The brittle snap data was analyzed using ANOVA and Tukey analysis. FIGS. 6 and 7 show the residual and interaction plots for the data, respectively. The summary of the ANOVA and Tukey analysis is shown in Table 1. The interaction plots show that the number of counts increases when breaking the node below the accelerometer and that when breaking the node below the accelerometer, the difference between the strong and weak hybrids is greater. Further, from the Tukey analysis, Table 1, the data in the lower node relative to the accelerometer position is able to separate the results into 3 bins. Brittle snap is a complex trait and from the preliminary data, the number of fibers compromised in the failure of the node may not be sufficient to screen a hybrid. Other parameters such as the amount of energy until breakage and the timing of the failure across the event of bending the stalk until failure may be of significance.

TABLE 1
Tukey analysis of the Total Acceleration - Brittle Snap

| | | | | #bins of SE |
|---|---|---|---|---|
| | | | | Difference in |
| | Difference | SE of | | Mean |
| | of Means | Difference | P Value | Difference |
| Upper | −0.2234 | 1.319 | 0.8665 | 1 |
| Lower | 2.528 | 1.188 | 0.0412 | 3 |

### Example 2

### Stalk Lodging Testing

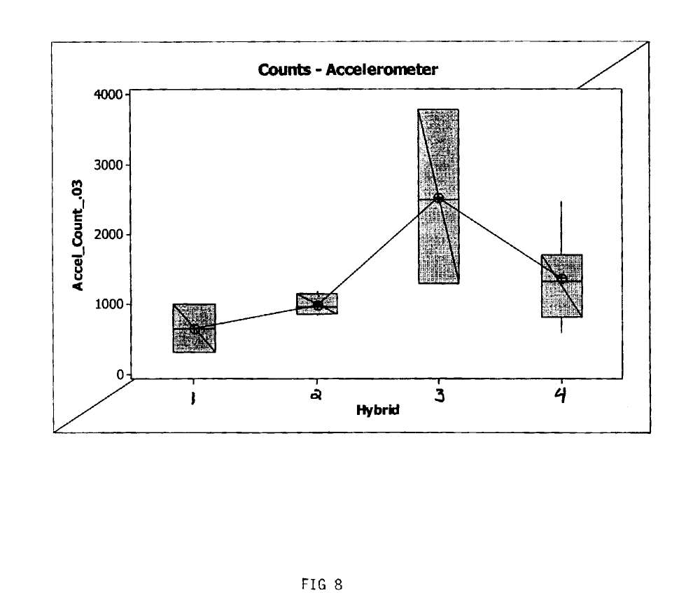

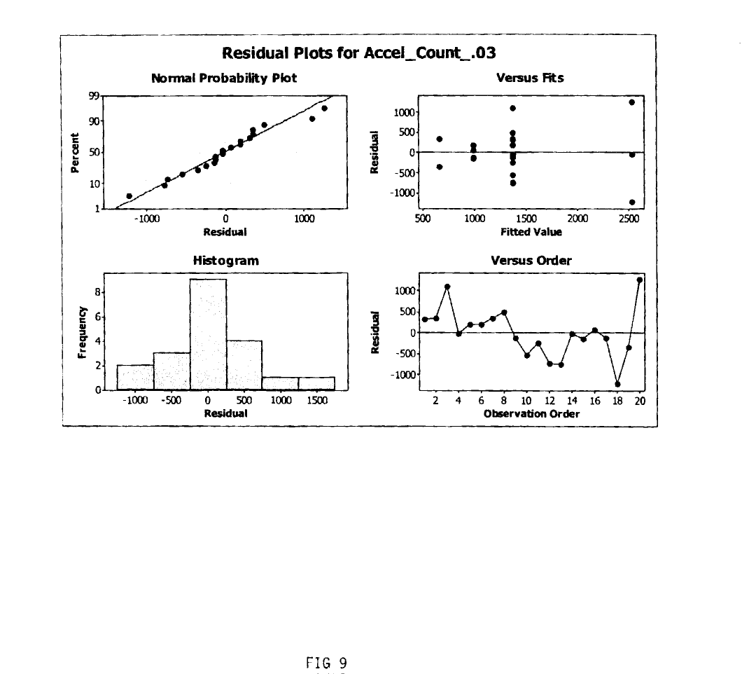

Four Pioneer maize hybrids (hybrids 1-4) with differences in their resistance to stalk lodging were measured. The machine was placed at a distance of between 15 and 20 cm above the ground near the top of the second internode. At the time of the test, the plants were at the R1 developmental stage. The null hypothesis tested was that hybrids with more resistance to stalk lodging will show no difference in the number of fibers recruited to failure than a weaker hybrid. FIG. 8 shows a boxplot for hybrids 1-4 of the number of counts after the stalk was pushed from the vertical position to the horizontal position (a rotation of 90°). FIG. 9 shows residual plots for hybrids 1-4 for the number of counts (number of fibers reaching structural failure) measured with the accelerometer during a breaking event. The ANOVA shows that the data does not support the null hypothesis. Accordingly, there are significant differences between contrasting hybrids. One-way ANOVA: Accel_Count_{—}0.03 versus Hybrid

| Source | DF | SS | MS | F | P |
|---|---|---|---|---|---|
| Entryname | 3 | 5645084 | 1881695 | 4.52 | 0.018 |
| Error | 16 | 6666181 | 416636 | | |
| Total | 19 | 12311265 | | | |

S = 645.5 R-Sq = 45.85% R-Sq(adj) = 35.70%

Four additional hybrids (hybrids 5-8) were tested with contrasting scores for stalk lodging, specifically two early and two late cycle hybrids were tested.
Hybrid 5—Late cycle hybrid with poor stalks and good roots
Hybrid 6—Late cycle hybrid with good stalks and good roots
Hybrid 7—Early cycle hybrid with good stalks and good roots
Hybrid 8—Early cycle hybrid with poor stalks and good roots

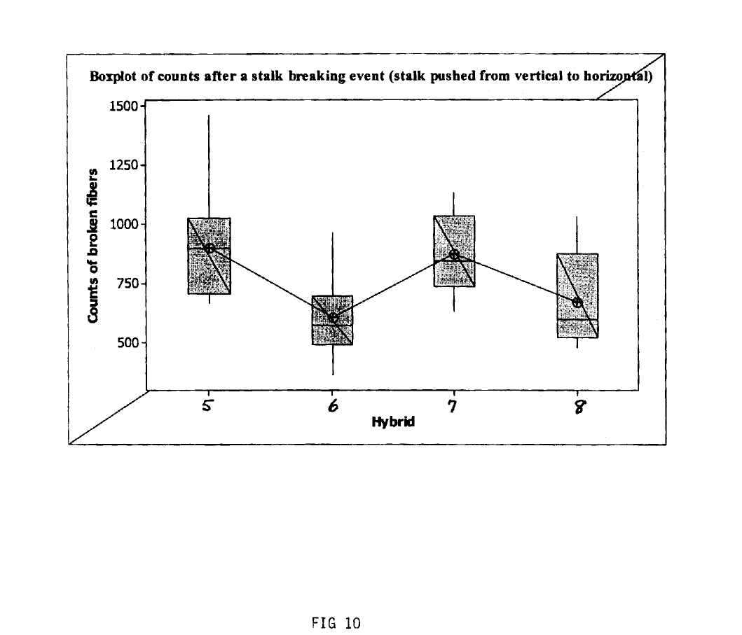

Testing was performed when the plants were at the R1 stage of development. The soil was not saturated but it had visible moisture and was loose which could allow for some root mass rotation. FIG. 10 shows a boxplot of the number of counts for hybrids 5-8 after the stalk was pushed from the vertical position to the horizontal position (a rotation of 90°). As shown in the ANOVA below, statistically significant differences were found between the late cycle hybrids. In the present test, the number of replicates was insufficient to separate the early cycle hybrids.

One-way ANOVA: Accel_Count_2 versus Entryname

| Source | DF | SS | MS | F | P |
|---|---|---|---|---|---|
| Entryname | 3 | 639796 | 213265 | 5.44 | 0.003 |
| Error | 36 | 1410502 | 39181 | | |
| Total | 39 | 2050298 | | | |

S = 197.9 R-Sq = 31.21% R-Sq(adj) = 25.47%
Individual 95% CIs For Mean Based on
Pooled StDev

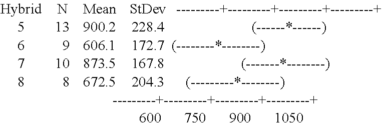

Pooled StDev = 197.9
Tukey 95% Simultaneous Confidence Intervals
All Pairwise Comparisons among Levels of Entryname
Individual confidence level = 98.93%

From this information it can be seen that a unique handheld device reliable in predicting important mechanical properties of plants has been designed and developed which enables the collection of meaningful and important data to facilitate plant breeding and product development processes. All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, it will be obvious that certain changes and modifications may be practiced within the scope of the appended claims. Thus, many modifications and other embodiments of the inventions set forth herein will come to mind to one skilled in the art to which these inventions pertain having the benefit of the teachings presented in the foregoing descriptions and the associated drawings. For example, though examples are presented herein, one skilled in the art will appreciate that the data may be analyzed in many different manners consistent with the parameters of the study being investigated. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation. The following examples are offered to further illustrate but not limit both the system and/or device and/or method.

From this information it can be seen that a unique handheld device reliable in predicting important mechanical properties of corn stalks has been designed and developed which enables the collection of meaningful and important data to facilitate corn breeding and product development processes.

What is claimed is:

1. A device for measuring corn plant susceptibility to stalk lodging snap, comprising:
a stalk holder to apply force to a corn stalk;
a transducer operably linked to the stalk holder to output a voltage signal related to force applied by the stalk holder;
an accelerometer for attachment to a corn stalk for measuring stalk vibrations as the stalk holder applies force to a stalk; and
a recorder for recording the voltage output signal of said transducer and the vibration output signal of said accelerometer operably linked to each of said transducer and said accelerometer.

2. The device of claim 1 which is portable.

3. A method of measuring corn plant susceptibility to stalk lodging, said plant having a root portion and a stalk portion, comprising:
applying a pushing force to the lower portion of a corn stalk to push the corn stalk over;
measuring the applied pushing force required to push the stalk over;
measuring the vibrations in the lower portion of the stalk caused by stalk breakage; and
determining the corn plant's stalk lodging properties from the measured pushing force and vibrations caused by stalk breakage.

4. The method of claim 3 wherein the pushing force to the lower portion of the corn stalk is measured in the region spanning the stalk's second and third internodes.

5. The method of claim 3 wherein the vibrations in the lower portion of the stalk are measured above the roots and below the first node of the plant.

6. A device for measuring corn plant susceptibility to brittle snap, comprising:
a stalk holder to apply force to a corn stalk;
a transducer operably linked to the stalk holder to output a voltage signal related to force applied by the stalk holder;
an accelerometer for attachment to a corn stalk for measuring stalk vibrations as the stalk holder applies force to a stalk; and
a recorder for recording the voltage output signal of said transducer and the vibration output signal of said accelerometer operably linked to each of said transducer and said accelerometer.

7. The device of claim 6 which is portable.

8. A method of measuring corn plant susceptibility to brittle snap, said plant having a root portion and a stalk portion, comprising:
applying a pushing force to a portion of a corn stalk at or below the primary ear node to push the corn stalk over;
measuring the applied pushing force required to push the stalk over;
measuring the vibrations in the stalk caused by stalk breakage; and
determining the corn plant's brittle snap properties from the measured pushing force and vibrations caused by stalk breakage.

9. The method of claim 8 wherein the pushing force to the corn stalk is measured in the region of the stalk's primary ear node.

10. The method of claim 8 wherein the vibrations are measured under the region of the stalk's primary ear node.
